(19) United States
(12) Patent Application Publication
(10) Pub. No.: US 2008/0260586 A1
(43) Pub. Date: Oct. 23, 2008

(54) Pillar Based Biosensor and Method of Making the Same

(75) Inventor: Marius Boamfa, Veldhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 12/092,891

(22) PCT Filed: Nov. 1, 2006
(86) PCT No.: PCT/IB06/54048

§ 371 Date: May 7, 2008

Related U.S. Application Data
(60) Provisional application No. 60/734,305, filed on Nov. 7, 2005.

(51) Int. Cl. G01N 21/64; B01J 19/00

(52) U.S. Cl. 422/82.08; 422/68.1

(57) ABSTRACT

A biosensor (10) comprises a top layer (12) and a plurality of pillar structures (14) formed integral with the top layer, the plurality of pillar structures extending from a surface of the top layer. The biosensor further includes a specific bio-layer (16) disposed about a perimeter of the pillar structures of the plurality of pillar structures.

The present disclosure generally relates to biosensors, and more particularly, to a pillar based biosensor and method of making the same.

In the field of molecular diagnostics, a biosensor is generally used to detect the presence and/or concentration of a target substance in an analyte. This detection is based on a specific binding to a “binding site” or capture probe which is immobilized on a substrate. In order to make this binding detectable a label element (hereinafter referred to as “label”) is attached to the target. The signal of the label needs to be detected with the highest possible sensitivity. There are different approaches to build such an assembly of capture probe—target—label (e.g. one can first attach the label to the target and then let that couple bind to the capture probe or one can first bind the target to the capture probe and in a second step label the immobilized targets). This is relevant if one wants to measure while the binding reaction is still going on, or for the problem of background signal from the solution and the required washing steps to remove non-specifically bound targets and/or labels. Though the presence of labels is measured, one is only interested in the labels which are attached to a target which is immobilized by a capture probe on a substrate.

In addition, a typical molecular diagnostic experiment screens a bio-sample, usually a liquid analyte mixture, for detection of certain biological components (the “target”), such as genes or proteins. This is done by detecting the occurrence of selective bindings of the target to a capture probe, which is attached to a solid surface. The dynamics of the selective bindings, known as well as “hybridization,” is one of the major aspects of the experiment. Ideally a highly efficient and fast hybridisation process is desired, where all target molecules hybridise the capture probes in the shortest possible time. As well, it is very important that the volume of the used bio-sample is kept as low as possible due to the costs involved in the sample preparation. The hybridisation step is followed by a washing step, where all unbounded target molecule are flushed away, and at last, a detection step. The detection standard is based on fluorescent detection of fluorescent labels attached to the target molecules. It is very important that the platform on which the experiments are carried on, the biosensor cartridge, is designed such that optimise the detection process. At present, it is common practice that the biosensor cartridge undergoes the different experimental steps in different stations. For example the hybridisation is performed in a hybridisation oven and it is placed subsequently in a washing station. Finally the cartridge is analysed in a different station, usually called a “scanner,” for fluorescence detection.

The most significant limitations in prior known molecular diagnostic methods are a low efficiency specific binding process and excessive hybridisation times. It is widely accepted that flow trough sensor configurations offer the best performances in terms of binding efficiency and hybridisation times. This is because a flow through structure, for example a porous media, uses a “volume effect” and maximizes the effective area where binding can take place. At the same time, the average distance between a molecule present in solution and a potential binding surface is kept to a minimum, minimising the hybridisation time, which is a diffusion-limited process. However, in terms of excitation-detection, such a flow trough configuration is not preferred, since the molecules of interest to be detected are buried in a volume structure. As a result, the molecules of interest are difficult to excite and any generated fluorescence therefrom is difficult to collect. Moreover, sensitive methods, such as con-focal or evanescent excitation, which can provide selective detection of the bounded molecules versus the unbounded ones, are completely prohibited in the prior known flow-through configuration.

Accordingly, an improved molecular diagnostic biosensor and method of making the same for overcoming the problems in the art is desired.

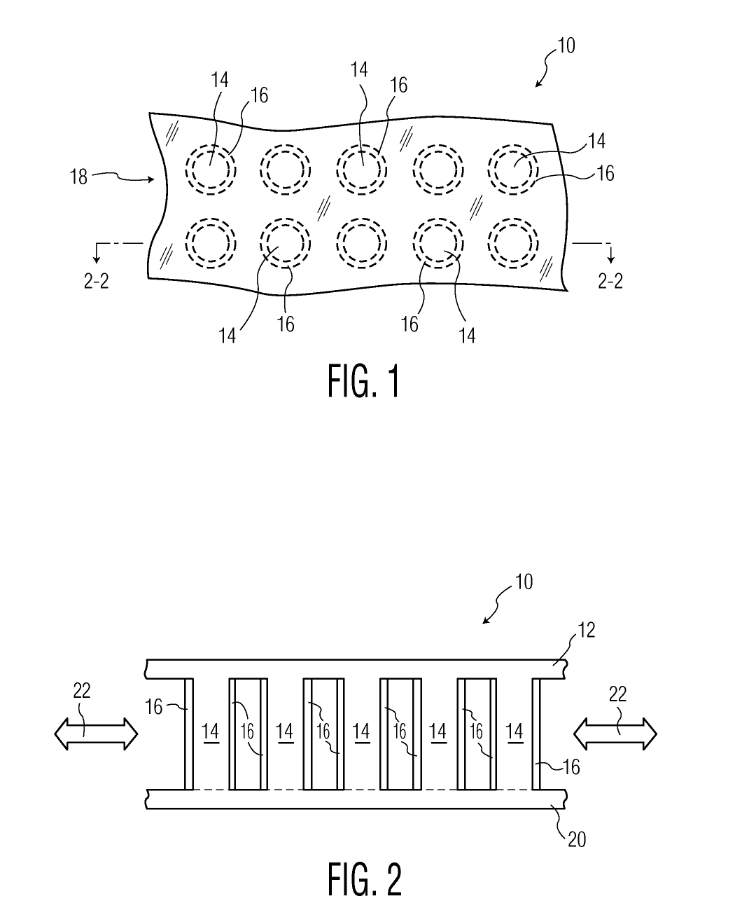

FIG. 1 is a top view of a portion of a pillar based biosensor according to one embodiment of the present disclosure;

FIG. 2 is a cross-sectional view along line 2-2 of the portion of the pillar based biosensor of FIG. 1 according to one embodiment of the present disclosure;

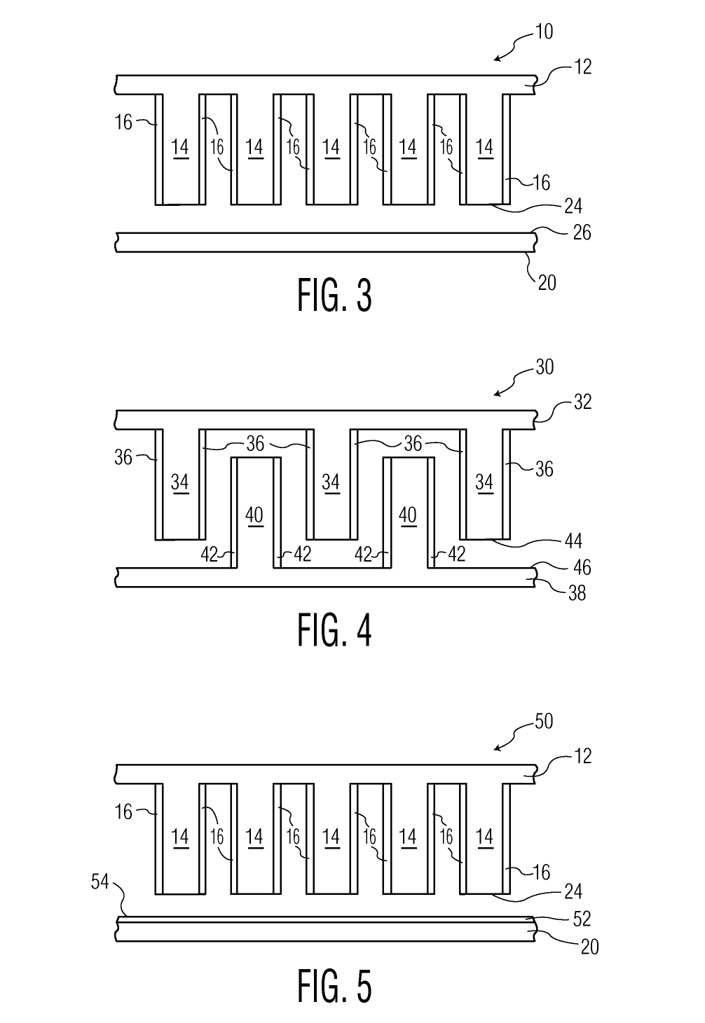

FIG. 3 is a cross-sectional view of a portion of the pillar based biosensor during a manufacture thereof according to one embodiment of the present disclosure;

FIG. 4 is a cross-sectional view of a portion of the pillar based biosensor during a manufacture thereof according to another embodiment of the present disclosure;

FIG. 5 is a cross-sectional view of a portion of the pillar based biosensor during a manufacture thereof according to yet another embodiment of the present disclosure;

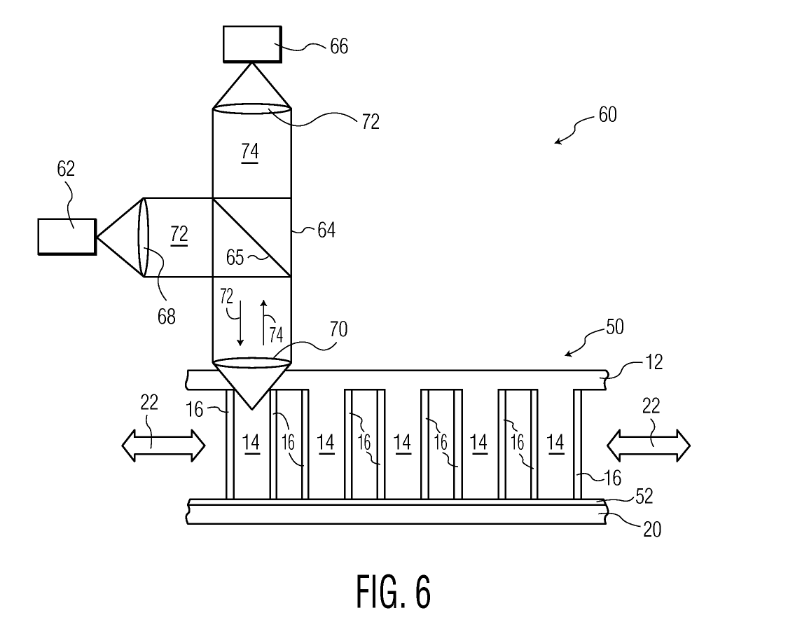

FIG. 6 is block diagram representation view of a scanning detection method for a pillar based biosensor according to an embodiment of the present disclosure;

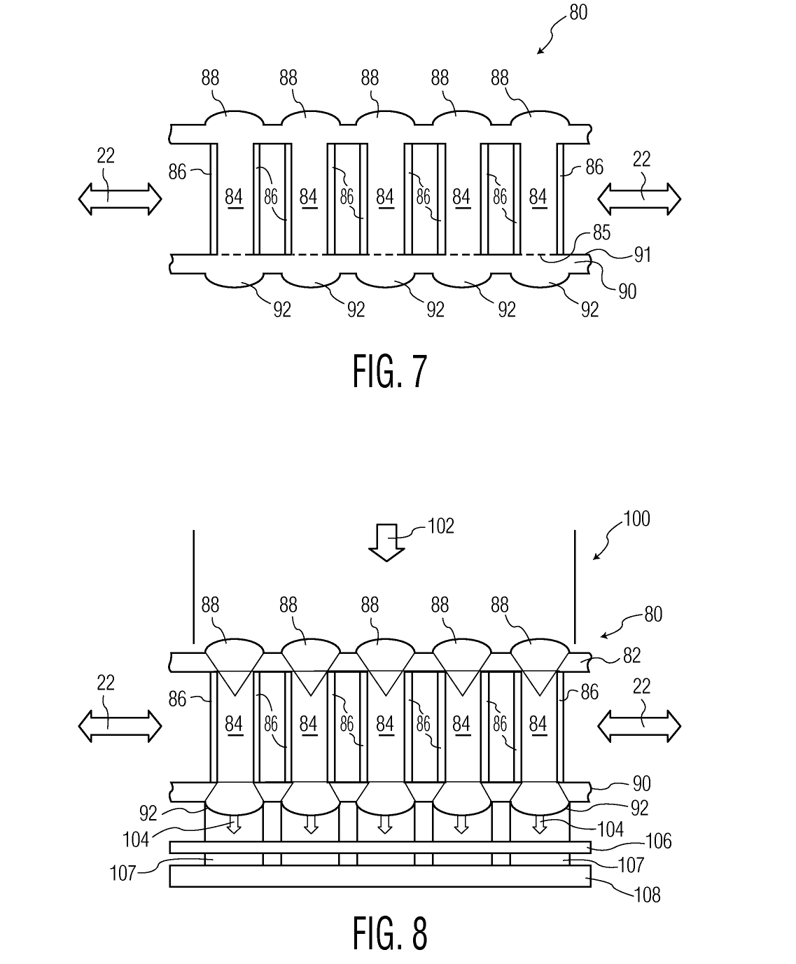

FIG. 7 is a cross-sectional view of a portion of a pillar based biosensor according to another embodiment of the present disclosure;

FIG. 8 is block diagram representation view of an imaging detection method for the pillar based biosensor of FIG. 7 according to an embodiment of the present disclosure;

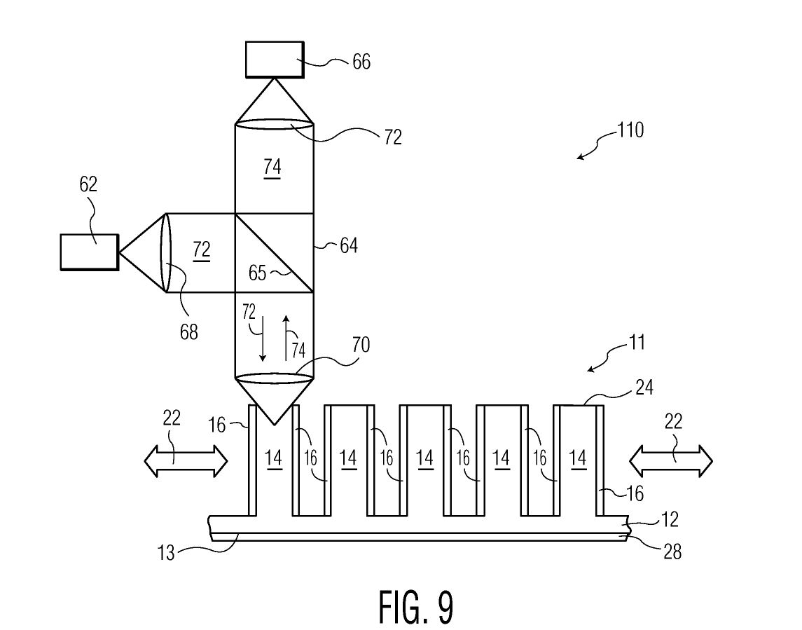

FIG. 9 is block diagram representation view of a scanning detection method for a pillar based biosensor according to another embodiment of the present disclosure;

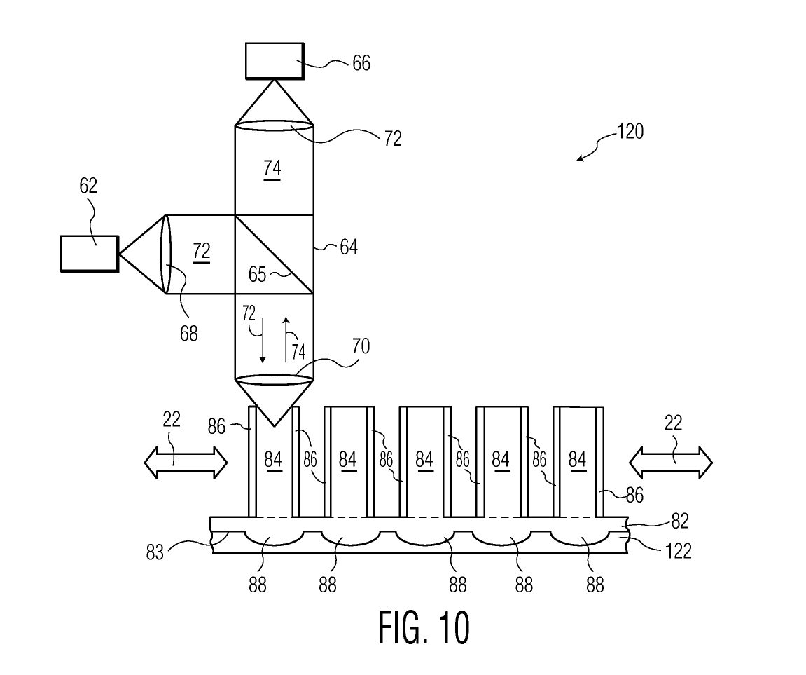

FIG. 10 is block diagram representation view of a scanning detection method for a pillar based biosensor according to yet another embodiment of the present disclosure; and

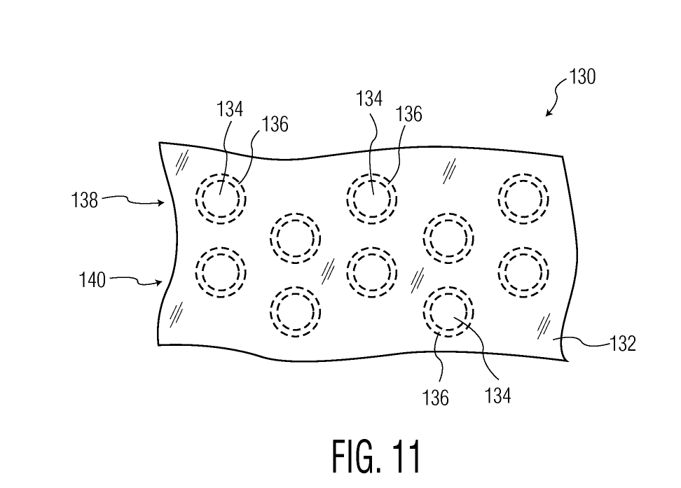

FIG. 11 is a top view of a portion of a pillar based biosensor according to another embodiment of the present disclosure.

In the figures, like reference numerals refer to like elements. In addition, it is to be noted that the figures and relative proportions of different parts are not drawn to scale.

According to the embodiments of the present disclosure, a novel biosensor uses evanescent excitation in a flow-through configuration. A central feature of the embodiments includes a pillar structure that maximizes the binding area, and allowing concurrent selective evanescent excitation of hybridised molecules against unbounded ones, as well as efficient collection of fluorescence light and thus providing for sensitive detection. In one embodiment, the biosensor includes a cartridge design. In particular, a biosensor comprises a periodic pillar structure that allows controlled evanescent excitation, specificity of bounded molecule detection and highly efficient fluorescence detection, while keeping the advantages of a flow through configuration. The pillar based biosensor structure is compatible with a method of injection molding replication, thus providing for low production cost per unit. In addition, the application of a bio-specific layer as discussed herein is relatively simple for the embodiments of the present disclosure, again with a direct influence on the cost per unit. The pillar structure according to the embodiments of the present disclosure maximizes the binding area and allows for concurrent (i) selective evanescent excitation of hybridised molecules against unbounded ones and (ii) efficient fluorescence detection.

FIG. 1 is a top view of a portion of a pillar based biosensor 10 according to one embodiment of the present disclosure. Pillar based biosensor 10 includes a top layer 12 and a plurality of pillar structures 14 having a specific bio-layer 16 disposed about a perimeter of the pillar structures 14. The pillar structures 14 and specific bio-layers 16 are illustrated in phantom lines to indicate that the same reside below the top layer 12. As illustrated in FIG. 1, the pillar structures are arranged in parallel rows of pillar structures, wherein one row is indicated by reference numeral 18.

FIG. 2 is a cross-sectional view along line 2-2 of the portion of the pillar based biosensor 10 of FIG. 1 according to one embodiment of the present disclosure. As indicated above, pillar based biosensor 10 includes a top layer 12 and a plurality of pillar structures 14 having a specific bio-layer 16 disposed about a perimeter of the pillar structures 14. In this embodiment, pillar based biosensor 10 includes a bottom layer 20. Arrows 22 illustrate a bi-directional flow of a suitable bio-carrier through regions in-between the pillar structures 14. The flow of bio-carrier comes in contact with respective specific biolayers 16 disposed about the perimeter of the pillar structures 14.

FIGS. 1 and 2 illustrate a principle of the pillar based biosensor according to one embodiment of the present disclosure in which a periodic pillar structure is embedded between two layers. The bio-carrier flow 22 is designed to be in a horizontal direction, as depicted in FIG. 2, and its flow characteristics (e.g., uniformity, flow rate, etc.) can be tailored by particular design of the pillar structure. In addition, the pillars 14 are coated with specific bio-layers 16, which function as molecule specific binding areas.

FIG. 3 is a cross-sectional view of a portion of the pillar based biosensor 10 during a manufacture thereof according to one embodiment of the present disclosure. In this embodiment, the pillar based biosensor 10 is fabricated using a modular fabrication technique. The fabrication technique includes separately fabricating a top portion (or first component part) and a bottom portion (or second component part), and then joining the top and bottom portions together to form the resultant pillar based biosensor. As illustrated, the top portion comprises top layer 12, pillar structures 14, and specific bio-layers 16. In one embodiment, the periodic pillar structures 14 and the top layer 12 can be manufactured or formed together, for example, using any suitable injection molding process. In addition, the specific bio-layers 16 can be added, for example, using any suitable deep coating process. Furthermore, the bottom portion comprises a bottom layer 20. In one embodiment, the bottom portion or structure is manufactured or formed using any suitable injection molding techniques, separately from the top portion or structure. Thin film techniques can also be used for adding a mirror to the bottom layer 20, as will be discussed further herein. Lastly, FIG. 3 illustrates the top portion and the bottom portion in a spaced-apart arrangement. When assembled, a bottom surface 24 of the pillar structures 14 is coupled to a top surface 26 of bottom layer 20, using any suitable attachment method to secure and hold the same together.

In one embodiment, typical dimensions of the pillar based biosensor structure include a pillar diameter on the order of between one to one-hundred microns (i.e., 1-100 microns). For efficient manufacturing, the length of any particular pillar should not exceed on the order of two to ten times (2-10×) its diameter. In one embodiment, a pillar based biosensor structure include pillars having a diameter on the order of twenty (20) microns and a length on the order of about sixty (60) microns, with an inter pillar distance on the order of about the pillar diameter. The latter embodiment takes into account the particularities of injection molding processes, combined with the deep coating possibility, in addition to obtaining a desired controlled bio-carrier flow.

FIG. 4 is a cross-sectional view of a portion of the pillar based biosensor during a manufacture thereof according to another embodiment of the present disclosure. In this embodiment, a pillar based biosensor 30 is fabricated using a modular fabrication technique. The fabrication technique includes separately fabricating a top portion (or first component part) and a bottom portion (or second component part), and then joining the top and bottom portions together to form the resultant pillar based biosensor. As illustrated, the top portion comprises top layer 32, pillar structures 34, and specific bio-layers 36. In one embodiment, the arrangement of pillar structures 34 and the top layer 32 can be manufactured or formed together, for example, using any suitable injection molding process. In addition, the specific bio-layers 36 can be added, for example, using any suitable deep coating process. The bottom portion comprises a bottom layer 38, pillar structures 40, and specific bio-layers 42. In one embodiment, the arrangement of pillar structures 40 and the bottom layer 38 can be manufactured or formed together, for example, using any suitable injection molding process. In addition, the specific bio-layers 42 can be added, for example, using any suitable deep coating process. In addition, in one embodiment the specific bio-layers 36 of the top portion and the specific bio-layers 42 of the bottom portion are of the same composition. In another embodiment, the specific bio-layers 36 of the top portion and the specific bio-layers 42 of the bottom portion are of different compositions.

Moreover, the top portion includes a first set of pillar structures 34 and the bottom portion includes a second set of pillar structures 40. In one embodiment, the first and second sets of pillar structures form complementary sets of pillar structures. In another embodiment, the top portion and the bottom portion of the pillar based biosensor 30 are complements of one another. In addition, FIG. 4 illustrates the top portion and the bottom portion in a spaced-apart arrangement. When assembled, a bottom surface 44 of the pillar structures 34 is coupled to a top surface 46 of bottom layer 38, using any suitable attachment method to secure and hold the same together.

FIG. 5 is a cross-sectional view of a portion of the pillar based biosensor during a manufacture thereof according to yet another embodiment of the present disclosure. In this embodiment, the pillar based biosensor 50 is fabricated using a modular fabrication technique. The fabrication technique includes separately fabricating a top portion (or first component part) and a bottom portion (or second component part), and then joining the top and bottom portions together to form the resultant pillar based biosensor. As illustrated, the top portion comprises top layer 12, pillar structures 14, and specific bio-layers 16. In one embodiment, the arrangement of pillar structures 14 and the top layer 12 can be manufactured or formed together, for example, using any suitable injection molding process. In addition, the specific bio-layers 16 can be added, for example, using any suitable deep coating process.

In addition, the bottom portion comprises a bottom layer 20 having a mirror 52 disposed on a surface of the bottom layer. In one embodiment, the bottom portion or structure is manufactured or formed using any suitable injection molding techniques, separately from the top portion or structure. Mirror 52 can comprise any suitable mirror or reflecting layer. For example, mirror 52 can comprise a reflective coating applied to the surface of the bottom layer 20 using any suitable thin film techniques, a mirror attached to the surface of bottom layer 20, or other similar mirror configuration. FIG. 5 illustrates the top portion and the bottom portion in a spaced-apart arrangement. When assembled, a bottom surface 24 of the pillar structures 14 is coupled to a top surface 54 of mirror 52 on bottom layer 20, using any suitable attachment method to secure and hold the same together. In an alternate embodiment, mirror 52 could be disposed on an opposite surface of the bottom layer, wherein the bottom layer is disposed in-between the mirror and the bottom surface of the pillar structures.

FIG. 6 is block diagram representation view of a scanning detection method for a pillar based biosensor according to an embodiment of the present disclosure. The detection method uses a detector 60 that includes laser device 62, dichroic beam splitter 64, detector 66, lens 68, lens 70, and lens 72. FIG. 6 represents only one of a number of possible scanning detectors that incorporate use of the pillar structure in a set-up, together with an excitation source and a detection unit.

Laser 62 provides a laser beam 72 that focuses on the end of a pillar 14 within pillar based biosensor 50. The refractive index of the pillar material is higher than a refractive index of a bio-carrier that is made to flow in the direction indicated by arrow 22. Accordingly, the laser light illuminated pillar acts as an optical fibre, confining the laser light inside of it. In addition, this configuration creates an evanescent field at the lateral surface of the pillar, extending enough to selectively excite the labeled molecules hybridised on the bio-layer 16 coating the pillar 14. The fluorescence of the excited fluorophores is efficiently collected inside the pillar. The mirror 52 at the other end of pillar takes care that the excitation light is efficiently used and that the collected fluorescence is directed toward the detector 66. The dichroic beam splitter 64 filters the reflected light (at 65), collected by the same lens 70 used to focus the light in the pillar, such that only the fluorescence light 74 reaches the detector 66. The design ensures that the evanescent field reaches much higher intensity than in prior known devices. A high evanescent field is a prerequisite for a better Signal-to-Noise Ratio (SNR) and a smaller integration time. Due to the evanescent excitation, a washing step is not necessary. In addition, the hybridisation dynamics can be monitored in situ.

FIG. 7 is a cross-sectional view of a portion of a pillar based biosensor 80 according to another embodiment of the present disclosure. Pillar based biosensor 80 includes a top layer 82 and a plurality of pillar structures 84 having a specific bio-layer 86 disposed about a perimeter of the pillar structures 84. Top layer 82 includes a plurality of micro-lenses 88. Each micro-lens 88 is aligned with a corresponding underlying pillar structure. In this embodiment, pillar based biosensor 80 includes a bottom layer 90. Bottom layer 90 includes a plurality of micro-lenses 92. Each micro-lens 92 is aligned with a corresponding overlying pillar structure. Arrows 22 illustrate a bi-directional flow of a suitable bio-carrier through regions in-between the periodic pillar structures 84. The flow of bio-carrier comes in contact with respective specific biolayers 86 disposed about the perimeter of the pillar structures 84.

FIG. 7 further illustrates a principle of the pillar based biosensor according to one embodiment of the present disclosure in which a periodic pillar structure is embedded between two layers. The bio-carrier flow 22 is designed to be in a horizontal direction, as depicted in FIG. 7, and its flow characteristics (e.g., uniformity, flow rate, etc.) can be tailored by particular design of the periodic pillar structure. In addition, the pillars 84 are coated with specific bio-layers 86, which function as molecule specific binding areas.

In the embodiment of FIG. 7, the pillar based biosensor 80 is fabricated using a modular fabrication technique. The fabrication technique includes separately fabricating a top portion (or first component part) and a bottom portion (or second component part), and then joining the top and bottom portions together to form the resultant pillar based biosensor 80. As illustrated, the top portion comprises top layer 82, pillar structures 84, and specific bio-layers 86. In one embodiment, the arrangement of pillar structures 84 and the top layer 82 can be manufactured or formed together, for example, using any suitable injection molding process. In addition, the specific bio-layers 86 can be added, for example, using any suitable deep coating process.

Furthermore, the bottom portion comprises bottom layer 90. In one embodiment, the bottom portion or structure is manufactured or formed using any suitable injection molding techniques, separately from the top portion or structure. Thin film techniques can also be used for adding a mirror to the bottom layer 90, as will be discussed further herein. Lastly, FIG. 7 illustrates the top portion and the bottom portion in an assembled arrangement in which a bottom surface 85 of the pillar structures 84 is coupled to a top surface 91 of bottom layer 90, using any suitable attachment method to secure and hold the same together. The pillar based biosensor 80 of FIG. 7 could also be fabricated using a fabrication method similar to that as described herein with respect to the embodiments of FIGS. 4 and 5.

FIG. 8 is block diagram representation view of an imaging detection method for the pillar based biosensor 80 of FIG. 7 according to an embodiment of the present disclosure. The detection method uses a detector 100 that includes an excitation light 102, filter 106, and detection array 108. Detection array 108 comprises any suitable detection array for detecting fluorescence light, for example, a CCD, CMOS, or similar array. FIG. 8 represents only one of a number of possible imaging detection methods that incorporate use of the pillar structure in a set-up, together with an excitation source and a detection unit.

The micro-lens structure efficiently couples an un-collimated excitation beam 102 into the biosensor pillar structure 80. The refractive index of the pillar material is higher than a refractive index of a bio-carrier that is made to flow in the direction indicated by arrow 22. The light coupled at top layer 82 into each of the pillars 84 generates an evanescent field extending into the specific bio-layer 86 exciting the fluorophores of the bounded molecules. A portion of the fluorescent light is efficiently coupled into the corresponding pillar structure 84. At the bottom layer portion 90 at other end of the respective pillar structures 84, the second micro-lens structure 92 optimally directs the light (i.e., excitation and fluorescence), indicated by reference numeral 104, toward the detection array 108. Prior to the detection array 108, filter 106 ensures that only the fluorescence light, as indicated by reference numeral 107, reaches the detector array 108.

FIG. 9 is block diagram representation view of a scanning detection method for a pillar based biosensor according to another embodiment of the present disclosure. The detection method uses a detector 110 that includes laser device 62, dichroic beam splitter 64, detector 66, lens 68, lens 70, and lens 72, similar to that disclosed and discussed herein with reference to FIG. 6. FIG. 9 represents only one of a number of possible scanning detectors that incorporate use of the pillar structure in a set-up, together with an excitation source and a detection unit. In this embodiment, however, the biosensor 11 is similar to that as disclosed and discussed with respect to FIGS. 1-3 and 5, with the exception that the first portion of the biosensor is used alone in an open flow arrangement and with a mirror. That is, the first portion is inverted so that the exposed surface 24 of the pillar structures 14 is in an upright orientation. In addition, a mirror 28 is disposed on a surface 13 of layer 12. Mirror 28 can comprise any suitable mirror or reflecting layer, for example, a reflective coating applied to the surface 13 of the layer 12, a planar mirror attached to the surface 13 of layer 12, or other similar mirror configuration. As shown in FIG. 9, the pillar based biosensor 11 is used in an open configuration, where an upper layer is not included. If evaporation of the bio-carrier is not an issue, then such an open configuration could potentially lead to lower manufacturing costs and possibly higher detection performances.

With reference still to FIG. 9, laser 62 provides a laser beam 72 that focuses on the end of a pillar 14 within pillar based biosensor 11. The refractive index of the pillar material is higher than a refractive index of a bio-carrier that is made to flow in the direction indicated by arrow 22. Accordingly, the laser light illuminated pillar acts as an optical fiber, confining the laser light inside of it. In addition, this configuration creates an evanescent field at the lateral surface of the pillar, extending enough to selectively excite the labeled molecules hybridised on the bio-layer 16 coating the pillar 14. The fluorescence of the excited fluorophores is efficiently collected inside the pillar. The mirror 28 at the other end of pillar takes care that the excitation light is efficiently used and that the collected fluorescence is directed toward the detector 66. The dichroic beam splitter 64 filters the reflected light (at 65), collected by the same lens 70 used to focus the light in the pillar, such that only the fluorescence light 74 reaches the detector 66. The design ensures that the evanescent field reaches much higher intensity than in prior known devices. A high evanescent field is a prerequisite for a better Signal-to-Noise Ratio (SNR) and a smaller integration time. Due to the evanescent excitation, a washing step is not necessary. In addition, the hybridisation dynamics can be monitored in situ.

FIG. 10 is block diagram representation view of a scanning detection method for a pillar based biosensor according to yet another embodiment of the present disclosure. The detection method uses a detector 120 that includes laser device 62, dichroic beam splitter 64, detector 66, lens 68, lens 70, and lens 72, similar to that disclosed and discussed herein with reference to FIGS. 6 and 9. FIG. 10 represents only one of a number of possible scanning detectors that incorporate use of the pillar structure in a set-up, together with an excitation source and a detection unit. In this embodiment, however, the biosensor 81 is similar to that as disclosed and discussed with respect to FIG. 7, with the exception that the first portion of the biosensor is used alone in an open flow arrangement and with a mirror. That is, the first portion is inverted so that the exposed surface 85 of the pillar structures 84 is in an upright orientation. In addition, a mirror 122 is disposed on a surface 83 of layer 82. Mirror 122 can comprise any suitable mirror or reflecting layer, for example, a reflective coating applied to the surface 83 of the layer 12, or other mirror configuration. As shown in FIG. 10, the pillar based biosensor 81 is used in an open configuration, where an upper layer is not included. If evaporation of the bio-carrier is not an issue, then such an open configuration could potentially lead to lower manufacturing costs and possibly higher detection performances.

With reference still to FIG. 10, laser 62 provides a laser beam 72 that focuses on the end of a pillar 84 within pillar based biosensor 81. The refractive index of the pillar material is higher than a refractive index of a bio-carrier that is made to flow in the direction indicated by arrow 22. Accordingly, the laser light illuminated pillar acts as an optical fibre, confining the laser light inside of it. In addition, this configuration creates an evanescent field at the lateral surface of the pillar, extending enough to selectively excite the labelled molecules hybridised on the bio-layer 86 coating the pillar 84. The fluorescence of the excited fluorophores is efficiently collected inside the pillar. The mirror 122 at the other end of pillar takes care that the excitation light is efficiently used and that the collected fluorescence is directed toward the detector 66. The dichroic beam splitter 64 filters the reflected light (at 65), collected by the same lens 70 used to focus the light in the pillar, such that only the fluorescence light 74 reaches the detector 66. The design ensures that the evanescent field reaches much higher intensity than in prior known devices. A high evanescent field is a prerequisite for a better Signal-to-Noise Ratio (SNR) and a smaller integration time. Due to the evanescent excitation, a washing step is not necessary. In addition, the hybridisation dynamics can be monitored in situ.

FIG. 11 is a top view of a portion of a pillar based biosensor 130 according to another embodiment of the present disclosure. Pillar based biosensor 130 includes a top layer 132 and a plurality of pillar structures 134 having a specific bio-layer 136 disposed about a perimeter of the pillar structures 134. The pillar structures 134 and specific bio-layers 136 are illustrated in phantom lines to indicate that the same reside below the top layer 132. As illustrated in FIG. 11, the pillar structures are arranged in serpentine rows of pillar structures, wherein a first row and a second row are indicated by reference numeral 138 and 140, respectively. While two pillar arrangements have been shown and described with reference to FIGS. 1 and 11, it should be understood that any manner of pillar structures, configurations or arrangements are possible.

According to one embodiment of the present disclosure, a biosensor comprises a top layer and a plurality of pillar structures formed integral with the top layer and extending from a surface of the top layer. In addition, a specific bio-layer is disposed about a perimeter of one or more pillar structures of the plurality of pillar structures. In another embodiment, the top layer includes a plurality of micro-lenses, further wherein each micro-lens of the plurality of micro-lenses is positioned overlying a respective one of the plurality of pillar structures. In yet another embodiment, the biosensor further comprises a mirror disposed on a top surface of the top layer, wherein the mirror reflects light into ends of the plurality of pillar structures. The mirror can comprise, for example, a thin film mirror.

Still further, in response to inverting the biosensor such that the top layer becomes a bottom layer, the plurality of pillar structures and the bottom layer together form a flow-through configuration for a bio-carrier flow that enables (i) selective evanescent excitation of hybridized molecules against unbounded ones and (ii) fluorescence detection. Moreover, the bottom layer and the plurality of pillar structures can further comprise a material having a refractive index that is higher than a refractive index of the bio-carrier.

In yet another embodiment, the top layer includes a plurality of micro-lenses, further wherein each micro-lens of the plurality of micro-lenses is positioned overlying a respective one of the plurality of pillar structures. The biosensor further comprises a mirror disposed on a top surface of the top layer. The mirror reflects light into ends of the plurality of pillar structures. In addition, in response to inverting the biosensor such that the top layer becomes a bottom layer, the plurality of pillar structures and the bottom layer together form a flow-through configuration for a bio-carrier flow in a direction generally perpendicular to a length dimension of the pillar structures that enables (i) selective evanescent excitation of hybridized molecules against unbounded ones and (ii) fluorescence detection. Moreover, the bottom layer and the plurality of pillar structures comprise a material having a refractive index that is higher than a refractive index of the bio-carrier.

In yet still another embodiment, the biosensor can further comprise a bottom layer, and a mirror disposed on one of a top or bottom surface of the bottom layer, wherein a combination of the bottom layer and mirror together is coupled to ends of the plurality of pillar structures, further wherein the mirror reflects light into the ends of the plurality of pillar structures. The mirror can comprise, for example, a thin film mirror. The bottom layer can further include a plurality of micro-lenses, wherein each micro-lens of the plurality of micro-lenses is positioned as a function of a respective one of the plurality of pillar structures.

The biosensor can be configured such that the plurality of pillar structures, the top layer, and the bottom layer together form a flow-through configuration for a bio-carrier flow in a direction generally perpendicular to a length dimension of the pillar structures that enables (i) selective evanescent excitation of hybridized molecules against unbounded ones and (ii) fluorescence detection. In addition, the top layer, the bottom layer, and the plurality of pillar structures can comprise a material having a refractive index that is higher than a refractive index of the bio-carrier.

Although only a few exemplary embodiments have been described in detail above, those skilled in the art will readily appreciate that many modifications are possible in the exemplary embodiments without materially departing from the novel teachings and advantages of the embodiments of the present disclosure. For example, the biosensors as described with respect to FIGS. 1-5, 7 and 11 could be further integrated in a more complex structure, for example, a biosensor cartridge. In addition, the embodiments of the present disclosure can be used for various applications in the field of molecular diagnostics, to include, but not be limited to: clinical diagnostics, point-of-care diagnostics, advanced bio-molecular diagnostic research—biosensors, gene and protein expression arrays, environmental sensors, food quality sensors, etc. Accordingly, all such modifications are intended to be included within the scope of the embodiments of the present disclosure as defined in the following claims. In the claims, means-plus-function clauses are intended to cover the structures described herein as performing the recited function and not only structural equivalents, but also equivalent structures.

1. A biosensor comprising:
a top layer;
a plurality of pillar structures formed integral with the top layer and extending from a surface of the top layer; and
a specific bio-layer disposed about a perimeter of one or more pillar structures of the plurality of pillar structures.

2. The biosensor of claim 1, wherein the top layer includes a plurality of micro-lenses, further wherein each micro-lens of the plurality of micro-lenses is positioned overlying a respective one of the plurality of pillar structures.

3. The biosensor of claim 1, wherein the top layer and the plurality of pillar structures together comprise an injection molded component part.

4. (canceled)

5. The biosensor of claim 1, further comprising:
a mirror disposed on a top surface of the top layer, wherein the mirror reflects light into ends of the plurality of pillar structures.

6. The biosensor of claim 5, wherein the mirror comprises a thin film mirror.

7. The biosensor of claim 1, wherein responsive to inverting the biosensor such that the top layer becomes a bottom layer, the plurality of pillar structures and the bottom layer together form a flow-through configuration for a bio-carrier flow that enables (i) selective evanescent excitation of hybridized molecules against unbounded ones and (ii) fluorescence detection.

8. The biosensor of claim 7, wherein the bottom layer and the plurality of pillar structures comprise a material having a refractive index that is higher than a refractive index of the bio-carrier.

9. The biosensor of claim 1, wherein the top layer includes a plurality of micro-lenses, further wherein each micro-lens of the plurality of micro-lenses is positioned overlying a respective one of the plurality of pillar structures, the biosensor further comprising:
a mirror disposed on a top surface of the top layer, wherein the mirror reflects light into ends of the plurality of pillar structures, and wherein responsive to inverting the biosensor such that the top layer becomes a bottom layer, the plurality of pillar structures and the bottom layer together form a flow-through configuration for a bio-carrier flow in a direction generally perpendicular to a length dimension of the pillar structures that enables (i) selective evanescent excitation of hybridized molecules against unbounded ones and (ii) fluorescence detection.

10. The biosensor of claim 9, wherein the bottom layer and the plurality of pillar structures comprise a material having a refractive index that is higher than a refractive index of the bio-carrier.

11. The biosensor of claim 1, further comprising:
a bottom layer; and
a mirror disposed on one of a top or bottom surface of the bottom layer, wherein a combination of the bottom layer and mirror together is coupled to ends of the plurality of pillar structures, further wherein the mirror reflects light into the ends of the plurality of pillar structures.

12. The biosensor of claim 11, wherein the mirror comprises a thin film mirror.

13. The biosensor of claim 11, wherein the bottom layer includes a plurality of micro-lenses, further wherein each micro-lens of the plurality of micro-lenses is positioned as a function of a respective one of the plurality of pillar structures.

14. The biosensor of claim 11, wherein the plurality of pillar structures, the top layer, and the bottom layer together form a flow-through configuration for a bio-carrier flow in a direction generally perpendicular to a length dimension of the pillar structures that enables (i) selective evanescent excitation of hybridized molecules against unbounded ones and (ii) fluorescence detection.

15. The biosensor of claim 14, wherein the top layer, the bottom layer, and the plurality of pillar structures comprise a material having a refractive index that is higher than a refractive index of the bio-carrier.

16. The biosensor of claim 1, wherein the top layer, plurality of pillar structures, and the specific bio-layer comprise a first component part, the biosensor further comprising:
a second component part coupled to the first component part.

17. (canceled)

18. The biosensor of claim 16, wherein the second component part comprises:
a bottom layer;
a second plurality of pillar structures formed integral with the bottom layer and extending from a surface of the bottom layer; and
a second specific bio-layer disposed about a perimeter of one or more pillar structures of the second plurality of pillar structures.

19. The biosensor of claim 18, wherein the top layer includes a plurality of micro-lenses, further wherein each micro-lens of the plurality of micro-lenses is positioned overlying a respective one of the plurality of pillar structures, and wherein the bottom layer includes a second plurality of micro-lenses, further wherein each micro-lens of the second plurality of micro-lenses is positioned underlying a respective one of the second plurality of pillar structures.

20. The biosensor of claim 18, wherein the top layer, the plurality of pillar structures of the first component part, the bottom layer, and the second plurality of pillar structures together form a flow-through configuration for a bio-carrier flow in a direction generally perpendicular to a length dimension of the pillar structures that enables (i) selective evanescent excitation of hybridized molecules against unbounded ones and (ii) fluorescence detection.

21. The biosensor of claim 20, wherein the top layer, the plurality of pillar structures of the first component part, the bottom layer, and the second plurality of pillar structures it comprise a material having a refractive index that is higher than a refractive index of the bio-carrier.

22. The biosensor of claim 18, further wherein the second plurality of pillar structures of the second component part comprise a complement of the plurality of pillar structures of the first component part.

23. (canceled)

24. (canceled)

25. (canceled)

26. (canceled)

27. (canceled)

28. (canceled)

29. (canceled)
